(19) United States
(12) Patent Application Publication
(10) Pub. No.: US 2025/0237735 A1
(43) Pub. Date: Jul. 24, 2025

(54) RF SIGNAL ABSORPTION MODULE

(71) Applicant: RFCORE CO.,LTD., Gyeonggi-do (KR)

(72) Inventor: Guk-Hyun JANG, Gyeonggi-do (KR)

(21) Appl. No.: 18/829,735

(22) Filed: Sep. 10, 2024

(30) Foreign Application Priority Data
Jan. 19, 2024 (KR) 10-2024-0008864

(51) Int. Cl. G01S 7/02

(52) U.S. Cl. CPC G01S 7/023

(57) ABSTRACT

An RF signal absorption module mounted on a radar panel that simultaneously transmits a plurality of RF signals to absorb interference signals generated as the plurality of RF signals are transmitted simultaneously, where the RF signal absorption module comprises: first conductor patterns formed on a circuit board in a shape of a rim within a unit cell of a square shape, in which the rim shape is divided into a plurality of segments and disposed at equal intervals; second conductor patterns connected to the plurality of segmented first conductor patterns to be formed in a shape of a spoke, in which the spoke shape is disposed to be segmented in the middle; and resistors disposed to be connected between the second conductor patterns segmented in the middle.

### BACKGROUND

The present invention relates to an RF signal absorption module, and more specifically, to an RF signal absorption module mounted on a radar panel that simultaneously transmits a plurality of RF signals like an Active Electronically Scanned Array (AESA) radar to effectively absorb interference signals generated as the plurality of RF signals are transmitted simultaneously.

Recently, as radar capable of simultaneously processing RF signals of a plurality of frequencies has been developed with advancement of semiconductor techniques and signal processing techniques, performance of phased array radar has been improved dramatically.

In contrast to the conventional non-active phased array radar that may transmit only RF signals of one frequency, Active Electronically Scanned Array (AESA) radar is spotlighted as it can transmit RF signals of any frequency in any direction.

The Active Electronically Scanned Array (AESA) radar described above simultaneously transmits RF signals from four radars to cover 360 degrees, and as the four RF signals act as interference signals to each other, performance of the radars is degraded.

The background art of the present invention is disclosed in Korean Patent Publication No. 10-2017-0098074 (published on Aug. 29, 2017).

### SUMMARY OF THE INVENTION

Therefore, the present invention has been made in view of the above problems, and it is an object of the present invention to provide an RF signal absorption module mounted on a radar panel that simultaneously transmits a plurality of RF signals like an Active Electronically Scanned Array (AESA) radar to effectively absorb interference signals generated as the plurality of RF signals are transmitted simultaneously.

The technical problems to be solved by the present invention are not limited to the technical problems mentioned above, and unmentioned other technical problems will be clearly understood by those skilled in the art from the following description.

To accomplish the above object, according to one aspect of the present invention, there is provided an RF signal absorption module mounted on a radar panel that simultaneously transmits a plurality of RF signals to absorb interference signals generated as the plurality of RF signals are transmitted simultaneously, the RF signal absorption module comprising: first conductor patterns formed on a circuit board in a shape of a rim within a unit cell of a square shape, in which the rim shape is divided into a plurality of segments and disposed at equal intervals; second conductor patterns connected to the plurality of segmented first conductor patterns to be formed in a shape of a spoke, in which the spoke shape is disposed to be segmented in the middle; and resistors disposed to be connected between the second conductor patterns segmented in the middle.

Preferably, the first conductor patterns may be segmented into four pieces and disposed at equal intervals, the second conductor patterns may be symmetrically connected to each of the four first conductor patterns, and the resistors may be disposed to be connected to each of the four second conductor patterns.

Preferably, each of the four first conductor patterns may be formed at an angle θ1 of 65° to 85° and disposed at equal intervals.

Preferably, resistance of the resistors disposed to be connected to each of the four second conductor patterns may be 80 to 120Ω.

Preferably, the first conductor patterns may be segmented into eight pieces and disposed at equal intervals, the second conductor patterns may be symmetrically connected to each of the eight first conductor patterns, and the resistors may be disposed to be connected to each of the eight second conductor patterns.

Preferably, each of the eight first conductor patterns may be formed at an angle θ2 of 32.5° to 42.5° and disposed at equal intervals.

Preferably, resistance of the resistors disposed to be connected to each of the eight second conductor patterns may be 80 to 120Ω.

Preferably, the first conductor patterns may be segmented into sixteen pieces and disposed at equal intervals, the second conductor patterns may be symmetrically connected to each of the sixteen first conductor patterns, and the resistors may be disposed to be connected to each of the sixteen second conductor patterns.

Preferably, each of the sixteen first conductor patterns may be formed at an angle θ3 of 16.25° to 21.25° and disposed at equal intervals.

Preferably, resistance of the resistors disposed to be connected to each of the sixteen second conductor patterns may be 80 to 120Ω.

### BRIEF DESCRIPTION OF THE DRAWINGS

FIG. 1 is a plan view showing a unit cell of an RF signal absorption module according to a first embodiment of the present invention.

FIG. 2 is a plan view showing a unit cell of an RF signal absorption module according to a second embodiment of the present invention.

FIG. 3 is a plan view showing a unit cell of an RF signal absorption module according to a third embodiment of the present invention.

FIG. 4 is a graph showing the absorption spectrum of an RF signal of an RF signal absorption module according to a second embodiment of the present invention.

### DETAILED DESCRIPTION OF THE PREFERRED EMBODIMENT

The detailed description of the present invention described below refers to the accompanying drawings, which show, as examples, specific embodiments in which the present invention can be embodied. These embodiments are described in sufficient detail so that those skilled in the art may embody the present invention. It should be understood that although various embodiments of the present invention are different from each other, they do not need to be mutually exclusive.

For example, specific shapes, structures, and features described herein may be implemented in another embodiment without departing from the principle of the present invention in relation to an embodiment, and it should be understood that the location or arrangement of individual components within each disclosed embodiment may be changed without departing from the principle of the present invention.

Accordingly, the detailed description provided below is not intended to be taken in a limiting sense, and if properly described, the scope of the present invention should be limited only by the appended claims, together with all ranges equivalent to what those claims insist.

In the drawings, similar reference numerals refer to identical or similar functions throughout various aspects, and the length, area, thickness, and the like may be exaggerated for convenience.

In addition, when a part “includes” a certain component, this means that it may further include another component rather than excluding the component unless specifically stated otherwise.

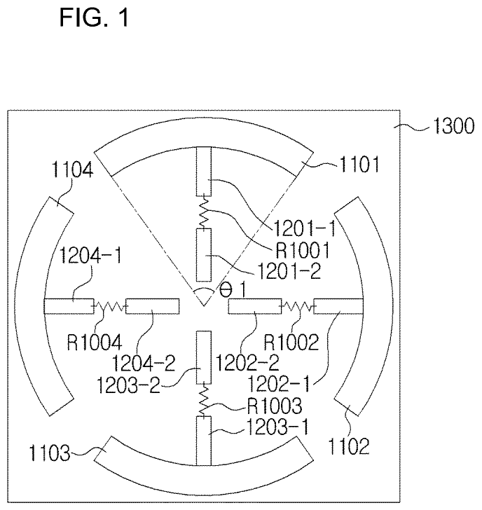

In order to be mounted on a radar panel that simultaneously transmits a plurality of RF signals and absorb interference signals generated as the plurality of RF signals are transmitted simultaneously, as shown in FIGS. 1 to 3, the RF signal absorption module according to the embodiments of the present invention includes first conductor patterns formed on a circuit board in a shape of a rim within a unit cell of a square shape, in which the rim shape is divided into a plurality of segments and disposed at equal intervals, second conductor patterns connected to the plurality of segmented first conductor patterns to be formed in a shape of a spoke, in which the spoke shape is disposed to be segmented in the middle, and resistors disposed to be connected between the second conductor patterns segmented in the middle.

Here, the circuit boards 1300, 2300, and 3300 may be configured as an epoxy resin board, and the first or second conductor patterns may be made of copper.

In the RF signal module according to a first embodiment of the present invention, as shown in FIG. 1, the first conductor patterns 1101, 1102, 1103, 1104 are segmented into four pieces and disposed at equal intervals, the second conductor patterns 1201-1, 1201-2, 1202-1, 1202-2, 1203-1, 1203-2, 1204-1, 1204-2 are symmetrically connected to each of the four first conductor patterns 1101, 1102, 1103, 1104, and the resistors R1001, R1002, R1003, R1004 are disposed to be connected to each of the four second conductor patterns 1201-1, 1201-2, 1202-1, 1202-2, 1203-1, 1203-2, 1204-1, 1204-2.

Here, each of the four first conductor patterns 1101, 1102, 1103, and 1104 may be formed at an angle θ1 of 65° to 85° and disposed at equal intervals as shown in FIG. 1, and resistance of the resistors R1001, R1002, R1003, R1004 disposed to be connected to each of the four second conductor patterns 1201-1, 1201-2, 1202-1, 1202-2, 1203-1, 1203-2, 1204-1, 1204-2 may be 80 to 120Ω.

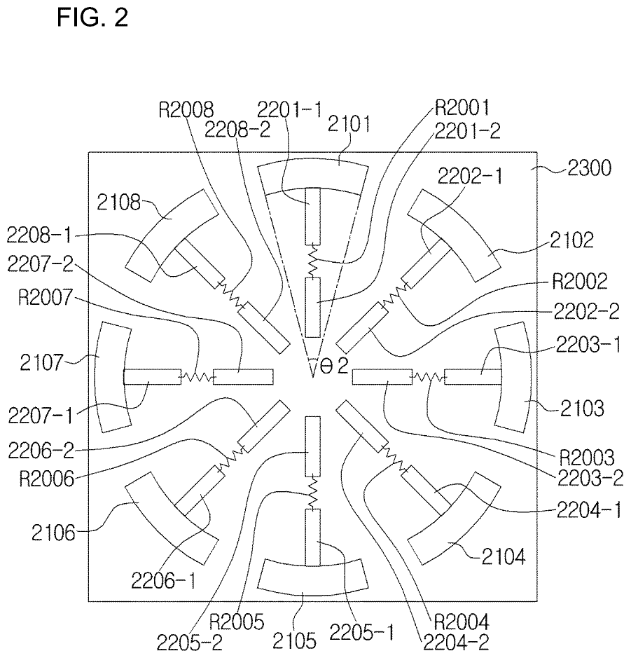

In addition, in the RF signal module according to a second embodiment of the present invention, as shown in FIG. 2, the first conductor patterns 2101, 2102, 2103, 2104, 2105, 2106, 2107, 2108 are segmented into eight pieces and disposed at equal intervals, the second conductor patterns 2201-1, 2201-2, 2202-1, 2202-2, 2203-1, 2203-2, 2204-1, 2204-2, 2205-1, 2205-2, 2206-1, 2206-2, 2207-1, 2207-2, 2208-1, 2208-2 are symmetrically connected to each of the eight first conductor patterns 2101, 2102, 2103, 2104, 2105, 2106, 2107, 2108, and the resistors R2001, R2002, R2003, R2004, R2005, R2006, R2007, R2008 are disposed to be connected to each of the eight second conductor patterns 2201-1, 2201-2, 2202-1, 2202-2, 2203-1, 2203-2, 2204-1, 2204-2, 2205-1, 2205-2, 2206-1, 2206-2, 2207-1, 2207-2, 2208-1, 2208-2.

Here, each of the eight first conductor patterns 2101, 2102, 2103, 2104, 2105, 2106, 2107, 2108 may be formed at an angle θ2 of 32.5° to 42.5° and disposed at equal intervals as shown in FIG. 2, and resistance of the resistors R2001, R2002, R2003, R2004, R2005, R2006, R2007, R2008 disposed to be connected to each of the eight second conductor patterns 2201-1, 2201-2, 2202-1, 2202-2, 2203-1, 2203-2, 2204-1, 2204-2, 2205-1, 2205-2, 2206-1, 2206-2, 2207-1, 2207-2, 2208-1, 2208-2 may be 80 to 120Ω.

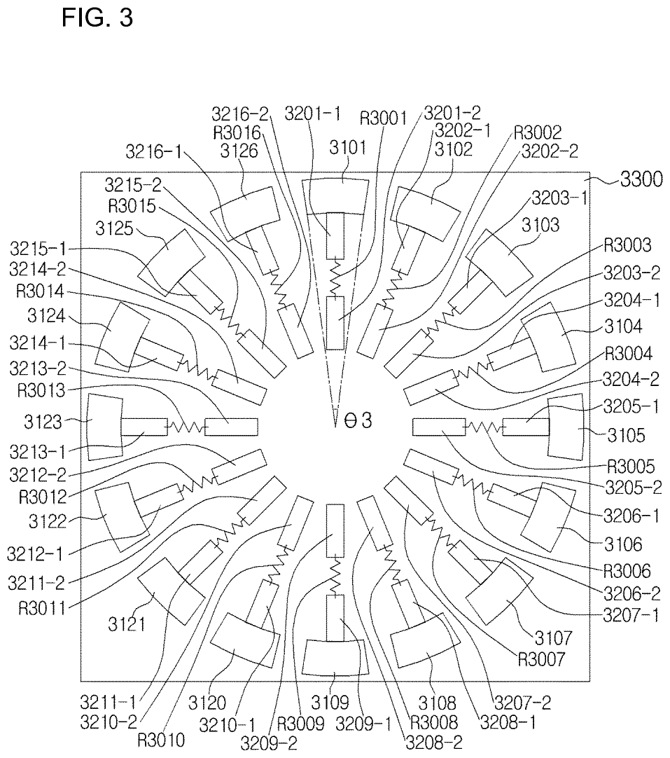

On the other hand, in the RF signal module according to a third embodiment of the present invention, as shown in FIG. 3, the first conductor patterns are segmented into sixteen pieces and disposed at equal intervals, the second conductor patterns are symmetrically connected to each of the sixteen first conductor patterns, and the resistors R3001, R3002, R3003, R3004, R3005, R3006, R3007, R3008, R3009, R3010, R3011, R3012, R3013, R3014, R3015, R3016 are disposed to be connected to each of the sixteen second conductor patterns.

Here, each of the sixteen first conductor patterns may be formed at an angle θ3 of 16.25° to 21.25° and disposed at equal intervals, and resistance of the resistors disposed to be connected to each of the sixteen second conductor patterns may be 80 to 120Ω.

The first conductor patterns of the RF signal module according to the embodiments of the present invention may be segmented into 32 or 64 pieces and disposed at equal intervals as needed.

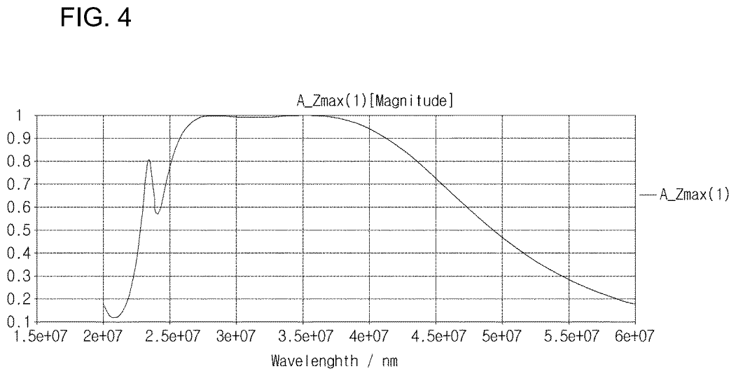

Hereinafter, a specific experiment example of the RF signal absorption module according to a second embodiment of the present invention will be described with reference to FIG. 4.

In the RF signal absorption module as shown in FIG. 2, the length of a unit cell is 15.7 mm, the major radius of the first conductor pattern is 7.6 mm and the minor radius is 6.4 mm, the angle θ2 of the first conductor pattern is 34°, the width of the second conductor pattern is 0.6 mm, the gap between the second conductor patterns is 2.0 mm, and the resistance of the resistors R2001 to R2008 connected to each of the second conductor patterns is 100Ω.

As shown in FIG. 4, it can be seen that the RF signal absorption module described above absorbs RF signals having a wavelength of 2.5 to 4.3 mm. Here, the absorption wavelength band of the RF signal may be controlled by adjusting the major radius, the minor radius, and the angle θ2 of the first conductor pattern, the width of the second conductor pattern and the gap between the second conductor patterns, and the resistance of the resistors R2001 to R2008 disposed to be connected to each of the second conductor patterns.

The RF signal absorption module according to the embodiments of present invention is mounted on a radar panel that simultaneously transmits a plurality of RF signals like an Active Electronically Scanned Array (AESA) radar and may effectively absorb interference signals generated as the plurality of RF signals are transmitted simultaneously.

Although the present invention has been described and illustrated in connection with preferred embodiments for illustrating the principle of the present invention, the present invention is not limited to the configuration and operation as shown and described.

Rather, those skilled in the art will understand that many changes and modifications can be made to the present invention without departing from the spirit and scope of the appended claims.

Accordingly, all such appropriate changes, modifications, and equivalents should be considered as falling within the scope of the present invention.

What is claimed is:

1. An RF signal absorption module mounted on a radar panel that simultaneously transmits a plurality of RF signals to absorb interference signals generated as the plurality of RF signals are transmitted simultaneously, the RF signal absorption module comprising:
first conductor patterns formed on a circuit board in a shape of a rim within a unit cell of a square shape, in which the rim shape is divided into a plurality of segments and disposed at equal intervals;
second conductor patterns connected to the plurality of segmented first conductor patterns to be formed in a shape of a spoke, in which the spoke shape is disposed to be segmented in the middle; and
resistors disposed to be connected between the second conductor patterns segmented in the middle.

2. The RF signal absorption according to claim 1, wherein the first conductor patterns are segmented into four pieces and disposed at equal intervals, the second conductor patterns are symmetrically connected to each of the four first conductor patterns, and the resistors are disposed to be connected to each of the four second conductor patterns.

3. The RF signal absorption according to claim 2, wherein each of the four first conductor patterns is formed at an angle θ1 of 65° to 85° and disposed at equal intervals.

4. The RF signal absorption according to claim 3, wherein resistance of the resistors disposed to be connected to each of the four second conductor patterns is 80 to 120Ω.

5. The RF signal absorption according to claim 1, wherein the first conductor patterns are segmented into eight pieces and disposed at equal intervals, the second conductor patterns are symmetrically connected to each of the eight first conductor patterns, and the resistors are disposed to be connected to each of the eight second conductor patterns.

6. The RF signal absorption according to claim 5, wherein each of the eight first conductor patterns is formed at an angle θ2 of 32.5° to 42.5° and disposed at equal intervals.

7. The RF signal absorption according to claim 6, wherein resistance of the resistors disposed to be connected to each of the eight second conductor patterns is 80 to 120Ω.

8. The RF signal absorption according to claim 1, wherein the first conductor patterns are segmented into sixteen pieces and disposed at equal intervals, the second conductor patterns are symmetrically connected to each of the sixteen first conductor patterns, and the resistors are disposed to be connected to each of the sixteen second conductor patterns.

9. The RF signal absorption according to claim 8, wherein each of the sixteen first conductor patterns is formed at an angle θ3 of 16.25° to 21.25° and disposed at equal intervals.

10. The RF signal absorption according to claim 9, wherein resistance of the resistors disposed to be connected to each of the sixteen second conductor patterns is 80 to 120Ω.
